(19) United States
(12) Patent Application Publication
(10) Pub. No.: US 2014/0263893 A1
(43) Pub. Date: Sep. 18, 2014

(54) Ball Holder

(71) Applicant: Jonathan Francis Loomis, Tacoma, WA (US)

(72) Inventor: Jonathan Francis Loomis, Tacoma, WA (US)

(21) Appl. No.: 13/846,944

(22) Filed: Mar. 18, 2013

(51) Int. Cl. F16M 13/02

(52) U.S. Cl. CPC F16M 13/02
USPC 248/205.3; 248/314; 248/205.1; 248/222.14

(57) ABSTRACT

The present invention relates to a ball holder designed to hold and display a single ball. The holder has a configuration of an arm/spine/arm, whereby each of the two arms have cut outs and project from the rear spine. This configuration enables the ball holder to hold a ball in the cut outs in a manner in which the arms of the ball holder exert pressure on the ball and the ball exerts pressure on the arms. The holder may be mounted on a vertical surface or set upright on a horizontal surface.

This application claims the benefit of U.S. Provisional Application No. 61/608,984 filed Mar. 9, 2012.

### FIELD OF THE INVENTION

The present invention relates, generally, to a ball rack or ball holder. More particularly, the invention relates to a ball rack designed to be mounted upright on a vertical flat surface, such as a wall.

### BACKGROUND

A large variety of devices are currently available for the storage of recreational and decorative balls, such as basketballs, soccer balls, footballs (American football), rugby balls, volleyballs, and so on. Such devices include, but are not limited to, basket-type storage units, shelves, tubular racks, wire mesh or fabric tubs, and sheet metal racks. Basket type ball storage units are often placed on the floor in a particular location. Many shelf type ball storage systems are fastened to a wall or are moveable units having wheels or similar means that allow rolling of the system to a desired location. These types of ball storage systems may be used to hold a single ball, but typically are designed to hold a multitude of two or more balls.

Ball storage devices typically are utilitarian in nature, such that they provide a means of holding balls in place. Without such storage devices, balls would be in a position or positions in which they could readily roll, bounce, and so on. Despite the advantages that present ball storage devices provide, they typically do not provide a means of holding just a single ball in place. Moreover, presently available ball storage devices typically do not provide a means of holding or displaying a ball in a decorative fashion. Thus, there remains a need in the art for a ball storage device that can hold a single ball, and do so in a decorative, aesthetically pleasing fashion. The present invention provides such a desirable ball holder that provides both ball storage and display.

### SUMMARY OF THE INVENTION

An object of the invention is to provide a ball holder that holds a single ball, the holder having a configuration of an arm, a spine, and a second arm. The arms have cut outs to hold the ball in place. The spine allows the holder to be mounted on a flat, vertical surface.

### BRIEF DESCRIPTION OF THE DRAWINGS

Some of the objects of the invention having been stated, other objects will appear as the description proceeds when taken in connection with the accompanying drawings, in which:

FIG. 1 shows a flat panel sheet from which a ball holder may be made.

FIG. 2 shows an angled, front view of a ball holder with a ball held in place.

FIG. 3 shows an overhead view of a ball holder with a ball held in place.

### DETAILED DESCRIPTION OF THE PREFERRED EMBODIMENTS

The present invention relates to a ball holder that provides a means for ball storage and display. In particular, the system provides a convenient and aesthetic holder for storing and/or displaying a single ball.

A ball holder according to the present invention is designed to be affixed to a vertical support surface or structure. Typically, the vertical support surface or structure will be a wall, but can be any vertical support surface or structure to which the ball storage and display system can be mounted or affixed. Alternatively, a ball holder of the present invention can be rested on a horizontal surface in an upright position, such that a ball is held and displayed in an upright holder without the holder being affixed to a vertical surface.

As used throughout this specification, the term “ball holder” refers to a ball storage and display device. The term “ball holder” is synonymous with any terminology that refers to a composition that is capable of holding a ball in place. For example, the term “ball holder” may be used interchangeably with the terms “ball rack,” “ball storage device,” “ball storage system,” “ball display device,” “ball display system,” and the like.

A ball holder of the instant invention will have a structure that includes, but is not limited to, a front panel that faces away from the vertical support surface and a back panel that faces toward the vertical support surface. The structure will include, but will not be limited to, three contiguous portions: an arm, a spine, and a second arm, whereby the spine is centered between the two arms. The spine is designed to rest flat against a vertical surface, and the two arms are designed to extend out from the spine and the vertical surface, when the ball holder is mounted to a vertical surface. The back side of the spine may be affixed to a vertical surface by any fastening means, such as, but not limited to, double stick tape, screws, bolts, nails, glue, and the like. If used on a horizontal surface, the ball holder will rest on the horizontal surface along the bottom edges of the two arms and the spine, such that the ball holder will sit upright and be able to hold a ball.

The two arms each contain a cut out or hole designed to allow a portion of a ball to extend through the cut out or hole. The ball holder will thereby store or hold a ball in place by holding two different portions of the ball that respectively extend through two different cut outs in each of the arms in the ball holder. In this manner, the ball holder will be capable of holding a ball in place by pressure, with inward pressure exerted toward the ball by the arms of the ball holder and outward pressure exerted toward the arms by the ball. A ball holder of the present invention is made to be used repeatedly, such that a ball may be placed in the holder and removed from the holder repetitively. In this manner, a ball holder of the present invention will maintain its shape and function after any number of uses, such as, but not limited to, 1, 5, 10, 20, 50, 100, 250, 500, 1000, and 10000 or more uses.

A ball holder of the present invention may be formed by any means that yields a final configuration of two arms extending from a central spine. In one embodiment, a ball holder will typically be formed from a flat sheet that is then shaped into the final ball holder contiguous configuration of an arm/spine/arm, and in which cut outs or holes are made. A ball holder may therefore be made from any flat shape(s) capable of forming the arm/spine/arm portions of the holder, and capable of having cut outs or holes made in the arms. Such shapes include, but are not limited to, a rectangle, a square, an oblong, a circle, a trapezoid, a parallelogram, and so on. In a preferred embodiment, a rectangle is used as the starting shape.

A ball holder of the present invention can be made by any method that results in the formation of the final configuration of an arm/spine/arm, as described above. In a preferred embodiment, the ball holder is made from a piece of plastic that is initially provided as a flat sheet. Cut outs are made in the sheet, and then the sheet is bent into the final shape of an arm/spine/arm configuration. The plastic is bent using a heated bending method, such that the molecules in the plastic are realigned in the bending process to yield a final configuration that retains its shape, both after bending and after repeated use. Alternatively, the sheet may be bent, followed by cutting out of the cut outs or holes. The ball holder will be made of a plastic that is between 2-5 mm thick, and more preferably 3-4 mm thick. The arms will preferably be bent from the spine to yield an angle of between 60-71 degrees, and more preferably an angle of 70 degrees.

Any material capable of being formed into a ball holder of the present invention may be used. For example, the ball holder may be made of plastic, metal, wood, and so on. In a preferred embodiment, the ball holder will be made of a rigid plastic, such as, but not limited to, ABS, polystyrene, polyethylene, various resins, and so on. In a more preferred embodiment, the ball holder will be made of a plastic that is between 2-5 mm thick, and more preferably 3-4 mm thick

A ball holder as instantly disclosed may be both functional and ornamental. The ball holder is functional in its ability to hold a ball in place. The ball holder may also be ornamental and have aesthetic qualities, since the front and/or back panels may have particular colors either embedded into the holder or printed or applied to the surface of the holder, and may likewise have graphics that are embedded into the holder or printed or applied to the surface. Colors and/or graphics that are applied to the surface may be done so by any typical means of application, whether directly printed onto the surface or applied to the surface as a decal or similar decoration. In this regard, the holder may have aesthetic qualities such as graphics, logos, colors, and the like on both or either of the front and back panels.

According to the present invention, a ball holder may be designed for any of a number of different types of balls of various shapes and sizes. Such ball types include, but are not limited to, basketballs, soccer balls, volley balls, tennis balls, baseballs, golf balls, and so on. A ball holder may be formed to hold virtually any round ball. Beyond round balls, a ball holder of the present invention may also be designed to hold an oblong type ball, such as football, rugby ball, Australian rules football, and the like.

To accommodate different types of balls, a ball holder of the present invention may be made of different dimensions as required to hold different types of balls. In this regard, a ball holder may be scaled for a particular type of desired ball to be held in place. For example, the size of the cut out can be adjusted, as can the location of the cut outs within the arms. For instance, a basketball holder and a soccer ball holder may use the same size cut out portions, with the cut outs being located at different proximities from the spine portion of the ball holder. In this instance, a basketball holder might have the cut outs further from the spine than a soccer ball holder.

Referring to FIGS. 1-3, an exemplary embodiment of the present invention is described. FIG. 1 displays a flat panel or sheet 2 from which the ball holder is made. The sheet will typically be made of a plastic, and will have a desired shape, such as the rectangular shape shown in FIG. 1. Two cut outs or holes 4 and 6 will be made in the sheet to provide cut outs or holes which will hold a ball within the final configuration ball holder. The dotted lines 8 and 10 represent regions in which the flat panel can be bent to form the final ball holder structure and angles between the arms and spine.

The flat panel or sheet 2 of FIG. 1 may be bent or shaped in a similar manner to provide a final shape as shown in FIGS. 2 and 3. FIG. 2 shows a frontward facing projection of a ball storage device 2 having a front panel 12 and a back panel 14. The front panel has 3 portions which include two forward facing arms 16 and 18, and a rear portion or spine 20. The outward projecting portions 16 and 18 contain cut outs or holes 4 and 6 respectively. When a ball 22 is placed into the ball holder, pressure is created by the holder against the ball and by the ball against the holder, which allows the ball holder to hold a ball. This aspect is depicted in both FIG. 2 and FIG. 3. FIG. 3 provides an overhead perspective, in which a ball is held in place between the two outward facing arms of the ball holder. As shown in FIG. 3, portions of the ball extend through the storage device. The pressure of the ball exerted on the holder, coupled with the pressure of the holder exerted on the ball, results in the ball being held in place in the storage device.

While this invention has been described as having particular configurations disclosed herein, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

The following example illustrates certain aspects of the invention, but are not intended to limit in any manner the scope of the invention.

### Example I

### A Functional and Aesthetic Basketball Holder

A basketball holder according to the present invention maybe be produced with the general configuration shown in FIGS. 1-3 as follows. A plastic sheet 3 mm thick may be cut to a rectangle of 11 inches high by 22 inches long. The contiguous sheet is divided into an arm 9 inches long, a spine 4 inches long, and a second arm 9 inches long. Two cuts out of 4.5 inches in diameter are made in each arm, 2 inches from the outer edge of each arm.

The sheet as shown in FIG. 1 is bent using a heat bending process, which causes the molecules in the plastic to be aligned and configured in the bent configuration after the structure cools. The angle between the arms and the flat surface against which the rack will sit is between 69 and 71 degrees, and preferably is 70 degrees.

1. A ball holder comprising a first arm, a spine, and a second arm, each arm extending forward away from the spine and having a cut out for holding a ball.

2. The ball holder of claim 1, wherein each arm extends forward away from the spine's back at an angle between 69 to 71 degrees.

3. The ball holder of claim 1, wherein each arm extends forward away from the spine's back at an angle of 70 degrees.

4. The ball holder of claim 1, wherein the ball holder is formed from a rigid plastic material.

5. The ball holder of claim 4, wherein the rigid plastic material is selected from the group consisting of ABS, polystyrene, and polyethylene.

6. The ball holder of claim 4, wherein the rigid plastic material is ABS.

7. The ball holder of claim 4, wherein the rigid plastic material is between 2 to 5 mm thick.

8. The ball holder of claim 4, wherein the rigid plastic material is 3 mm thick.

9. The ball holder of claim 1, further comprising a fastening means for affixing the ball holder by its spine to a vertical surface.

10. The ball holder of claim 9, wherein the fastening means is selected from the group consisting of double stick tape, screws, bolts, nails, and glue.

11. A ball holder comprising a contiguous material configured to form a first arm, a spine, and a second arm, each arm extending forward away from the spine and having a cut out for holding a ball.

12. The ball holder of claim 11, wherein each arm extends forward away from the spine's back at an angle between 69 to 71 degrees.

13. The ball holder of claim 11, wherein each arm extends forward away from the spine's back at an angle of 70 degrees.

14. The ball holder of claim 11, wherein the contiguous material is a rigid plastic material.

15. The ball holder of claim 14, wherein the rigid plastic material is selected from the group consisting of ABS, polystyrene, and polyethylene.

16. The ball holder of claim 14, wherein the rigid plastic material is ABS.

17. The ball holder of claim 14, wherein the rigid plastic material is between 2 to 5 mm thick.

18. The ball holder of claim 14, wherein the rigid plastic material is 3 mm thick.

19. The ball holder of claim 11, further comprising a fastening means for affixing the ball holder by its spine to a vertical surface.

20. The ball holder of claim 19, wherein the fastening means is selected from the group consisting of double stick tape, screws, bolts, nails, and glue.
